(19) United States
(12) Patent Application Publication
(10) Pub. No.: US 2009/0079840 A1
(43) Pub. Date: Mar. 26, 2009

(54) METHOD FOR INTELLIGENTLY CREATING, CONSUMING, AND SHARING VIDEO CONTENT ON MOBILE DEVICES

(75) Inventors: Bhavan R. GANDHI, Vernon Hills, IL (US); Crysta J. Metcalf, Cary, IL (US); Kevin J. O'Connell, Palatine, IL (US); Cuneyt M. Taskiran, Chicago, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/860,580

(22) Filed: Sep. 25, 2007

(51) Int. Cl. H04N 5/228; H04N 11/02

(52) U.S. Cl. 348/222.1; 375/240.01; 375/E07.076; 348/E05.031

(57) ABSTRACT

A method, apparatus, and electronic device for processing video data are disclosed. A video capture mechanism 202 may capture the video data. A key frame extractor 204 may extract a key frame from the video data automatically based on a set of criteria. A video encoder 206 may encode the video data with a key frame identifier.

### 1. FIELD OF THE INVENTION

The present invention relates to a method and system for processing and analyzing video data. The present invention further relates to extracting key frames from a set of video data.

### 2. INTRODUCTION

Many handheld devices currently may be capable of capturing video content and storing the video content in a digital form. Many users of video data wish to process the video data, such as labeling the data and improving picture quality. The users also may wish to share the video data with other users, such as sending video of their children's soccer games to their relatives.

Handheld devices may generally sacrifice memory and processing power compared to a general computer system to increase portability. This reduced memory and processing power may result in limiting the ability of the handheld device in processing and distributing the video content.

### SUMMARY OF THE INVENTION

A method, apparatus, and electronic device for processing video data are disclosed. A video capture mechanism may capture the video data. A key frame extractor may extract at least one key frame from the video data automatically based on a set of criteria. A video encoder may encode the video data with a first key frame identifier.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates in a block diagram one embodiment of a handheld device.

FIG. 2 illustrates in a block diagram one embodiment of an audio-video processing system.

FIG. 3 illustrates in a block diagram one embodiment of the key frame extractor module.

FIG. 4 illustrates in a block diagram one embodiment of a criteria table to be used by the criteria manager module.

FIG. 5 illustrates in a flowchart one embodiment of a method for capturing and processing video.

FIG. 6 illustrates in a flow block diagram one embodiment of a user interface presenting the key frames to a user.

FIG. 7 illustrates in a flowchart one embodiment of a method of allowing a user to designate secondary key frames.

FIG. 8 illustrates in a flowchart one embodiment of a method for manipulating the video data set using a key frame user interface.

FIG. 9 illustrates in a flowchart one embodiment of a method for rearranging the video data set using a key frame user interface.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method, an apparatus, and an electronic device, and other embodiments that relate to the basic concepts of the invention. The electronic device may be any manner of computer, mobile device, or wireless communication device.

A method, apparatus, and electronic device for processing video data are disclosed. A video capture mechanism may capture the video data. A key frame extractor may extract at least one key frame from the video data automatically based on a set of criteria. A video encoder may encode the video data with a first key frame identifier.

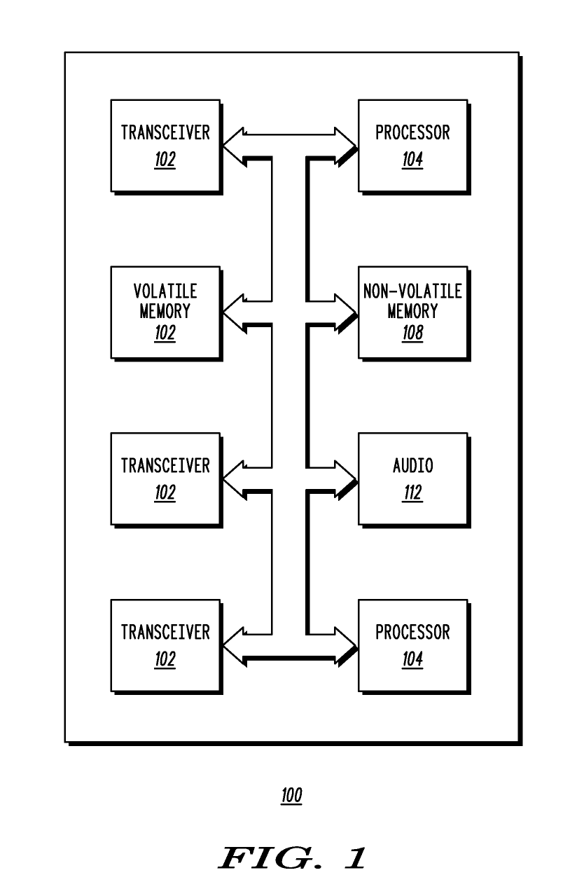

FIG. 1 illustrates in a block diagram one embodiment of a handheld device 100 that may be used to implement the video processing method. While a handheld device is described, any computing device, such as a desktop computer or a server, may implement the video processing method. The handheld device 100 may access the information or data stored in a network. The handheld device 100 may support one or more applications for performing various communications with the network. The handheld device 100 may implement any operating system, such as Windows or UNIX, for example. Client and server software may be written in any programming language, such as C, C++, Java or Visual Basic, for example. The handheld device 100 may be a mobile phone, a laptop, a personal digital assistant (PDA), or other portable device. For some embodiments of the present invention, the handheld device 100 may be a WiFi capable device, which may be used to access the network for data or by voice using voice over internet protocol (VOIP). The handheld device 100 may include a transceiver 102 to send and receive data over the network.

The handheld device 100 may include a controller or processor 104 that executes stored programs. The controller or processor 104 may be any programmed processor known to one of skill in the art. However, the decision support method may also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein can be used to implement the decision support system functions of this invention.

The handheld device 100 may also include a volatile memory 106 and a non-volatile memory 108 to be used by the processor 104. The volatile 106 and nonvolatile data storage 108 may include one or more electrical, magnetic or optical memories such as a random access memory (RAM, cache, hard drive, or other memory device. The memory may have a cache to speed access to specific data. The memory may also be connected to a compact disc-read only memory (CD-ROM), digital video disc-read only memory (DVD-ROM), DVD read write input, tape drive or other removable memory device that allows media content to be directly uploaded into the system.

The handheld device 100 may include a user input interface 110 that may comprise elements such as a keypad, display, touch screen, or any other device that accepts input. The handheld device 100 may also include a user output device that may comprise a display screen and an audio interface 112 that may comprise elements such as a microphone, earphone, and speaker. The handheld device 100 also may include a component interface 114 to which additional elements may be attached, for example, a universal serial bus (USB) interface or an audio-video capture mechanism. Finally, the handheld device 100 may include a power supply 116.

Client software and databases may be accessed by the controller or processor 104 from the memory, and may include, for example, database applications, word processing applications, video processing applications as well as components that embody the decision support functionality of the present invention. The user access data may be stored in either a database accessible through a database interface or in the memory. The handheld device 100 may implement any operating system, such as Windows or UNIX, for example. Client and server software may be written in any programming language, such as ABAP, C, C++, Java or Visual Basic, for example.

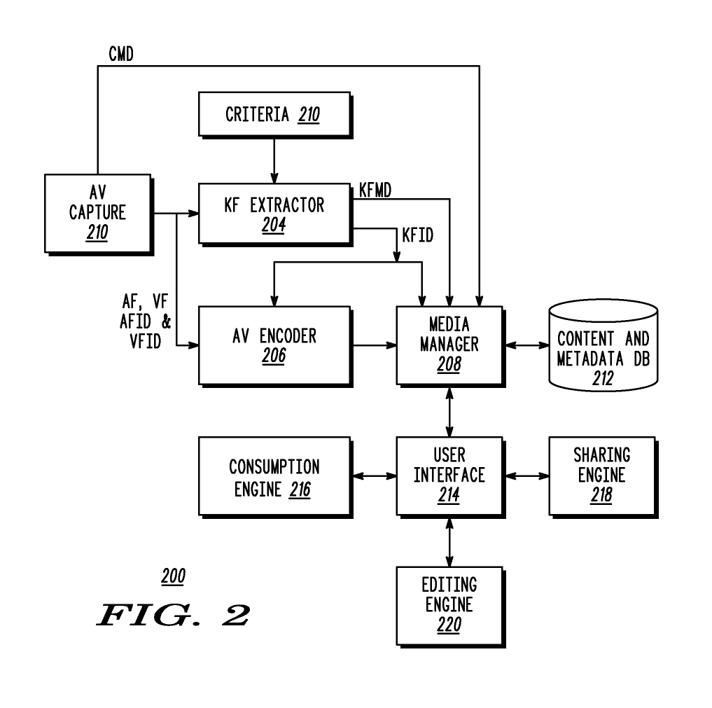

FIG. 2 illustrates in a block diagram one embodiment of an audio-video processing system 200. The described modules may be hardware, software, firmware, or other devices. The audio-video (AV) capture mechanism 202 may capture raw video data along with its context metadata. The raw video data may be solely video data or audio and video data. The context metadata conveys information about the context of the capture of the audio and video data, such as the location, date, time and other information about the capture of the video. The AV capture mechanism 202 may output the raw audio and video data as video frames (VF) with identifiers (VFID) and audio frames (AF) with identifiers (AFID) to a key frame (KF) extractor module 204 and an AV encoder module 206. The AV capture mechanism 202 may output the context metadata (CMD) into a media manager module 208.

The KF extractor module 204 may select representative video frames, referred to as key frames. The key frames may provide significant differentiation from one part of the video sequence to another. The KF extractor module 204 may determine which frames to select as a key frame based on statistical features as well as semantic features extracted from each frame. The KF extractor module 204 may automatically extract a key frame with different types of semantic features based on a set of criteria 210, such as user preferences, device capacities, and other data. The KF extractor module 204 may output key frame identifier information (KFID) to the AV encoder module 206 and the media manager module 208. The KF extractor module 204 may output the associated metadata associated with the specific key frame (KFMD) to the media manager module 208.

The AV encoder module 206 may receive as input raw audio and video data together with the KFID information to generate compressed bit stream representation of the video sequence. The AV encoder module 206 may intra-code the KFID information on the frame associated with the KFID information. Many coding standards have mechanisms to intra-code specific video frames. These standards may include International Telecommunication Union (ITU) Telecommunication Standardization Sector (ITU-T) standards H.261, H.263, H.264; Moving Picture Experts Group (MPEG) standards MPEG-1, MPEG-2, and MPEG-4; and other standards. An intra-coded video frame is a syntax that is self-contained and not dependent on previously encoded frames, and thus may efficiently be decoded without having to decode previously encoded frames. The AV encoder module 206 may provide the index information for the location of key frames in the compressed bit stream (KFIndex).

The media manager module 208 may receive a bit stream, KFMD, KFID, KFIndex data, and the CMD. The media manager module 208 may facilitate storage of the compressed video data and associated key frame information, such as the KFIndex, the KFID, and the CMD, into a database 212. While a single database 212 is shown that contains both the compressed video data and the metadata, the database 212 may physically store both the metadata information and the video data in multiple locations in the form of a distributed database.

A user interface 214 may allow a user to navigate through content that has been stored in the database 212. The user interface 214 may use an intelligent navigation to navigate through video content on a mobile device in a hierarchical fashion. The navigation may use metadata associated with the video content.

The user interface 214 may allow access to the high level video content, meaningful key frames, and video segments as demarcated by the key frames. The user interface 214, by interacting with a consumption engine 216, may allow for targeted consumption of either key frames, parts of the video, or the entire video itself.

The user interface 214 may allow for sharing the video content or appropriate parts of the video content. Sharing entire video clips may be prohibitively expensive from a channel bandwidth perspective, whereas sub-segments of the video may be sufficient for sharing. A sharing engine 218 may work with the user interface 214 to allow sharing of selected key frames, video sub-segments, as well as the entire video.

The user interface 214 may allow for editing the video content or segments of the video content. An editing engine 220 may interact with the user interface 214 to edit the video data. The user interface 214 may receive a user selection of a key frame to be deleted, causing the editing engine 220 to delete the video segment associated with the selected key frame. The user interface 214 may receive a user selection of a key frame to be edited, causing the editing engine 220 to edit the video segment associated with the selected key frame. The editing engine 220 may edit the metadata associated with the video segment or key frame, or edit the content of the key frame or video segment itself. Content editing may include processing the video data to improve clarity, adding scene change effects, adding visible titles or commentary, or other video data editing. The user interface 214 may receive a user direction to rearrange the viewing order of the key frames, causing the editing engine 220 to arrange the video segments in the order of the associated key frames.

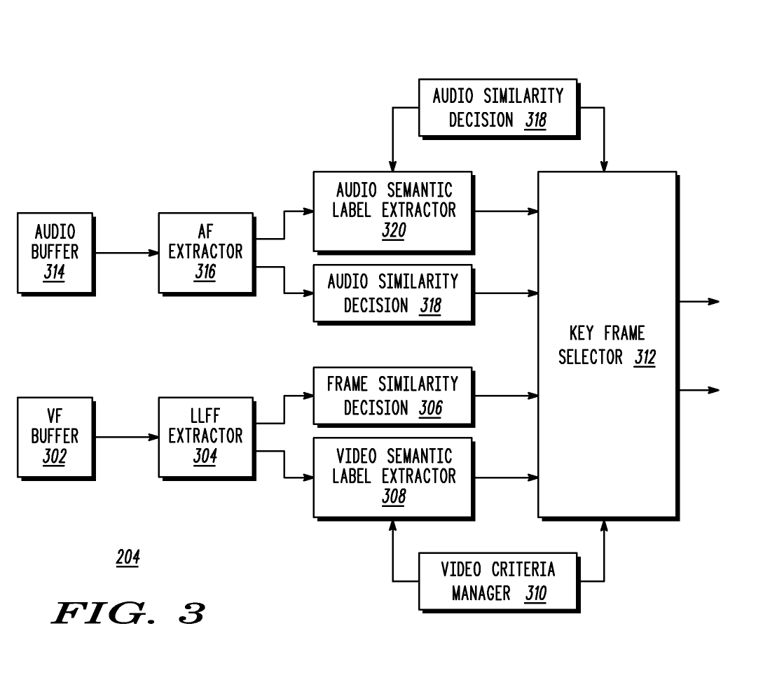

FIG. 3 illustrates in a block diagram one embodiment of the KF extractor module 204. The KF extractor module 204 may take as input video frame data and determine key frames that best match user preferences. The KF extractor module 204 may buffer input video frame data in the frame buffer 302, providing a window of N+1 frames to facilitate key frame extraction. The low-level frame feature (LLFF) extractor module 304 may perform low-level image processing to extract features from each video frame in the frame buffer 302. The LLFF extractor 304 may extract such features as color histograms, motion vectors, and other factors. The LLFF extractor module 304 may pass these low-level descriptions of the video frames to both a frame similarity decision module 306 and a video semantic label extractor module 308. The frame similarity decision module 306 may analyze interframe distances derived from low-level features to determine dissimilar frames and mark them as key frame candidates.

The video semantic label extractor module 308 may further process the low-level features to generate appropriate semantic labels for each frame, such as “face/non-face”, “indoor/outdoor”, “image quality” or “location”. Each semantic label extracted by the semantic label extractor module 308 may have an associated weight provided by a video criteria manager module 310 that determines the importance, and hence computational resources, placed on generating that specific semantic label. The video criteria manager module 310 may track and update the weights based on pre-defined, manually set, or learned user preferences. A key frame selection module 312 may receive both the frame similarity information along with frame semantic information. The key frame selection module 312 may select each key frame based on the frame's similarity to previous statistically determined different frames, the importance of the semantic content contained within the frame, the maximum number of key frames desired to represent captured video content, and other criteria.

A KF extractor module 204 may have separate modules to process audio data, or may process the audio data using the video processing modules. In a KF extractor module 204 that uses separate audio modules, the KF extractor module 204 may buffer input audio frame data in the audio buffer 314, providing a window of N+1 audio frames to facilitate key frame extraction. The audio frame (AF) extractor module 316 may perform low-level audio processing to extract features from each audio frame in the audio buffer 314. The AF extractor module 316 may extract such features as volume differentiation, pitch differentiation, and other factors. The AF extractor module 316 may pass these low-level descriptions of the audio frames to both an audio similarity decision module 318 and an audio semantic label extractor module 308. The audio similarity decision module 318 may analyze interframe distances derived from low-level features to determine dissimilar frames and mark them as key frame candidates.

The audio semantic label extractor module 320 may further process the low-level audio features to generate appropriate semantic labels for each frame. Each semantic label extracted by the audio semantic label extractor module 320 may have an associated weight provided by an audio criteria manager module 322 that determines the importance, and hence computational resources, placed on generating that specific semantic label. The audio criteria manager module 322 may track and update the weights based on pre-defined, manually set, or learned user preferences. The key frame selection module 312 may receive both the frame similarity information along with frame semantic information.

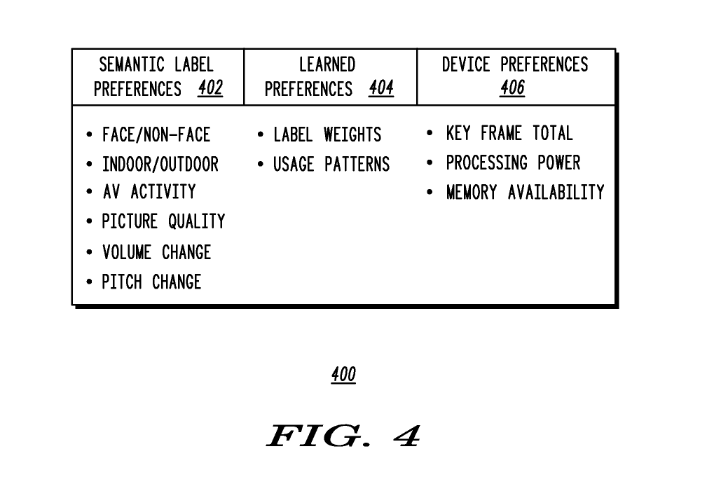

FIG. 4 illustrates in a block diagram one embodiment of a criteria table 400 to be used by the criteria manager module 310. The audio criteria manager module 322, the video criteria manager module 310, or a combined audio video criteria manager module may use a combined criteria table. Alternatively, the criteria manager modules may each maintain their own table. A semantic label preferences field 402 may store the weights of different semantic labels that may be derived by the semantic label extractor 308. If key frames showing a certain semantic quality are more important to users, a higher weight for the semantic label of that semantic quality may be specified compared to other labels. These weights may have a default setting based on research on user preferences or left for the user to specify. The weight of a label may be set to zero, resulting in the label not being extracted at all.

The semantic label preferences field 402 may include face/non-face, indoor/outdoor, AV activity, picture quality, or other semantics qualities of the video data. A face/non-face label may identify key-frames showing people. This label may further trigger a face recognition module to increase the ease with which a user might identify important frames. An indoor/outdoor label may identify a change in location, signaling a change in focus of the video data. An AV activity label may identify a change in activity, signaling “highlights” of events. A picture quality label may identify a key frame that will produce a thumbnail intelligible by the user for purposes of determining the value of the key frame. A volume change label may identify a key frame that has a change in volume for the audio, such as an increase in crowd noise indicating a major event in the video has just occurred. A pitch change label may identify a key frame that has a higher or lower pitched audio track.

A learned preferences field 404 may store a set of user preferences automatically learned by the criteria manager module 310 from usage history using machine learning techniques. The learned preferences field 404 may contain usage patterns for the various users. The criteria manager module 310 may adjust the label weights of the semantic label preferences field based upon these usage patterns. For example, usage behavior such as sending, fast-forwarding, and changing labels or titles may indicate key frames that are most useful or meaningful to users.

A device preferences field 406 may store device preferences representing computational and display capabilities of the particular mobile device used. The criteria manager module 310 may adjust the associated weights of the semantic label preferences 402 based upon the device preferences 406. Device preferences 406 may include number of key frames preferred by the user, processing power of the device, available memory, and other device features.

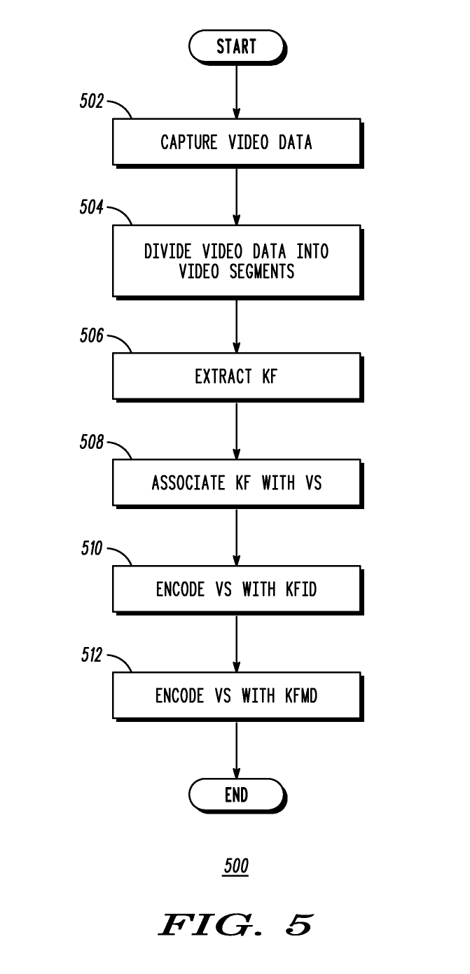

FIG. 5 illustrates in a flowchart one embodiment of a method 500 for capturing and processing video. The AV capture mechanism 202 may capture a clip of video data as video frames (Block 502). The clip of video data may be solely video data or video and audio data. The AV capture mechanism 202 may divide the clip of video data into a set video segments (Block 504). The KF extractor module 204 may extract a key frame (KF) (Block 506). The KF extractor module 204 may associate KF with a video segment (VS) containing KF in the set of video segments (Block 508). The AV encoder 206 may encode VS of the video data with an identifier of KF (KFID), or a key frame identifier (Block 510). The media manager module 208 may encode VS of the video data with the metadata describing KF (KFMD), or key frame metadata (Block 512).

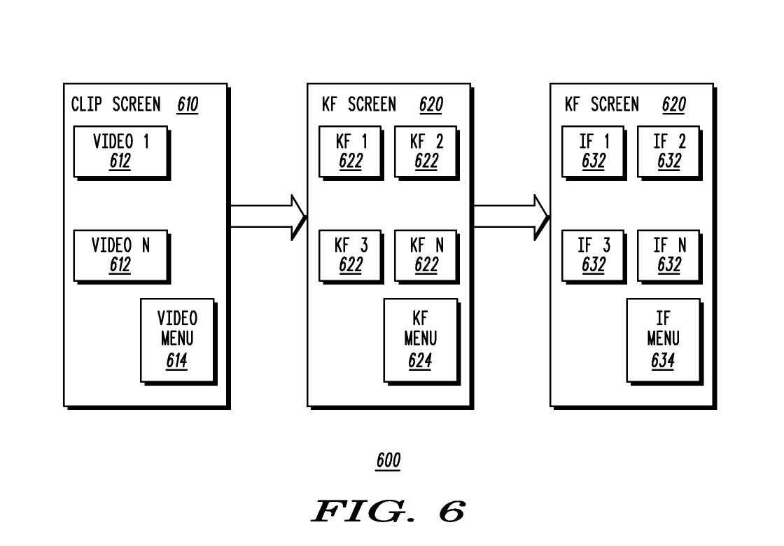

FIG. 6 illustrates in a flow block diagram one embodiment of a user interface 600 presenting the key frames to a user. The user interface 214 may present to a user a clip view screen 610 with video icons 612 that indicate an entire video clip available for selection. The video icon 612 may be a thumbnail of a main key frame associated with the video clip. The clip view screen 610 may include a clip menu 614 that provides actions the AV processing system 200 may perform on the selected video clips.

If a user wishes to process the video data at a video segment level, the user interface 214 may present a key frame (KF) view screen 620 displaying KF icons 622 indicating video segments available for selection. The KF icon 622 may be a thumbnail of a key frame and associated with the video segment. The KF view screen 620 may have a KF menu 624 that provides actions the AV processing system 200 may perform on the selected video segments.

If a user wishes to process the video data in the video segment at an individual frame level, the user interface 214 may present an individual frame (IF) view screen 630 displaying IF icons 632 available for selection. The IF icon 632 may be a thumbnail of an individual frame. The IF view screen 630 may have an IF menu 634 that provides actions the AV processing system 200 may perform on the selected individual frames. The IF view screen 630 may limit the presented individual frames to key frames within the video segment, the key frames not being linked to video segments. The key frames presented in the IF view screen 630 may be extracted using the same method to extract linked key frames.

The clip menu 614, KF menu 624, and IF menu 634 may provide a number of actions that may be performed on the video data at the whole clip, video segment, and individual frame level depending upon the view screen and menu. A consumption option, or “play”, may use the consumption engine 216 to play the full clip from beginning to end at the whole clip level or playing a complete video segment from beginning to end at a video segment level. A viewing option, or “view”, may use the consumption engine 216 to show a full screen image of the selected main key frame at the whole clip level, the selected key frame at the video segment level, or the selected individual frame at the individual frame level. A recap option, or “slide show”, may use the consumption engine 216 to show a slideshow of the available main key frames at the whole clip level, the available key frames at the video segment level, or the available individual frames at the individual frame level. A sharing option, or “send”, may use the sharing engine 218 to transmit a selected whole clip, a selected video segment, or a selected individual frame. Additionally, the sharing option may use the sharing engine 218 to transmit just the main key frame for a clip or a key frame for a video segment if selected by the user. An editing option, or “edit”, may use the editing engine 220 to edit the metadata, such as the semantic label, title, or other metadata, of the selected whole clip, the selected video segment, or the selected individual frame. With more complex editing engines 220, the editing option may also allow the user to perform editing of the video content itself. A transitional option, or “browse”, may use the user interface 214 and the media manager 208 to access the key frames of a video clip and the individual frames of a video segment.

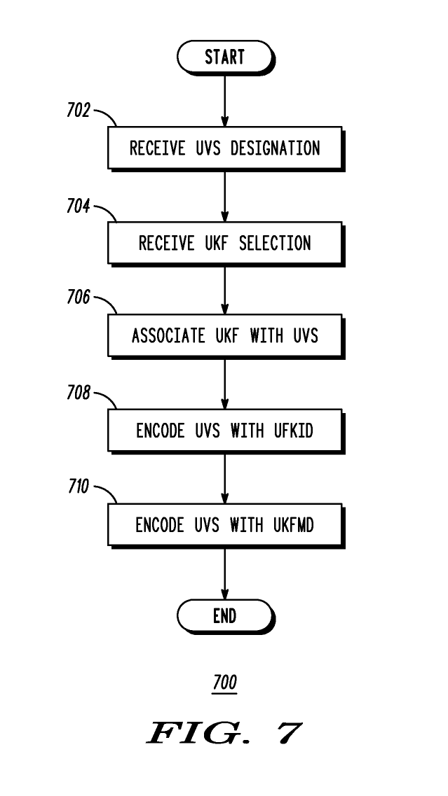

FIG. 7 illustrates in a flowchart one embodiment of a method 700 of allowing a user to designate secondary key frames. A user interface 214 may receive a designation from a user of a user video segment (UVS) in the clip of video data (Block 702). For example, a user may press one button when viewing the initial frame of a video segment and the same button or a second button when viewing the final frame of a video segment. The user interface 214 may receive from the user a selection of an individual frame as a user key frame (UKF) (Block 704). For example, a user may press one button when viewing a frame the user deems a key frame. The editing engine 220 may associate UKF with UVS (Block 706). The editing engine 220 may encode the UVS with a key frame identifier for UKF (UKFID) (Block 708). The editing engine 220 may encode UVS with key frame metadata describing UKF (UKFMD) (Block 710).

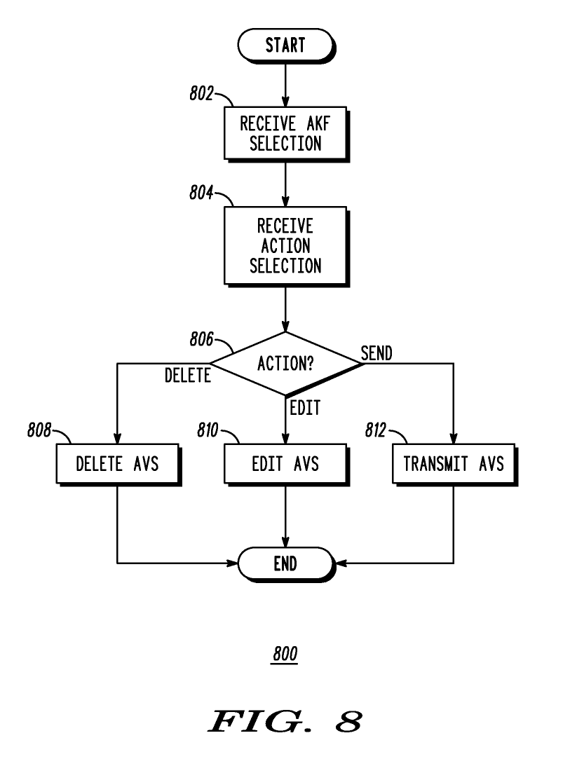

FIG. 8 illustrates in a flowchart one embodiment of a method 800 for manipulating the video data set using a key frame user interface. The user interface 214 may receive from the user a selection of an action key frame (AKF) (Block 802). The user interface 214 may receive an action selection from the user (Block 804). If the action is a delete action (Block 806), the editing engine 220 may delete the video segment associated with the AKF (AVS) (Block 808). If the action is an edit action (Block 806), the editing engine 220 may edit the AVS (Block 810). If the action is a send action (Block 806), the sharing engine 218 may transmit the AVS to a designated entity (Block 812). The user may enter the designated entity via the user interface 214 or select the entity from a predetermined list. The sharing engine 218 may have a designated entity set as a default.

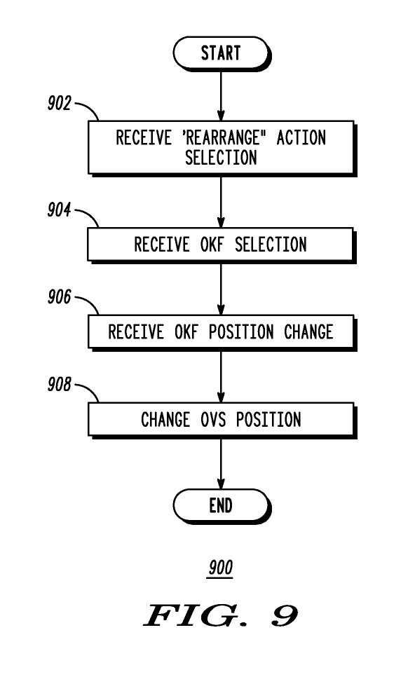

FIG. 9 illustrates in a flowchart one embodiment of a method 900 for rearranging the video data set using a key frame user interface. A user interface 214 may receive a “rearrange” action selection from a user (Block 902). A user interface 214 may receive a selection of an ordering key frame (OKF) from the user (Block 904). The user interface 214 may receive a position change of the OKF from the user (Block 906). The user may indicate the position change by selecting a key frame and dragging the key frame to a different place in the order of the key frames. The editing engine 220 may change the position of the video segment associated with the OKF (OVS) to reflect the new position of the OKF (Block 908).

Although not required, the invention is described, at least in part, in the general context of computer-executable instructions, such as program modules, being executed by the electronic device, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof through a communications network.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the electronic devices each processing the content in various possible ways. It does not necessarily need to be one system used by all end users. Accordingly, the appended claims and their legal equivalents should only define the invention, rather than any specific examples given.

We claim:

1. A method for processing video data, comprising:
extracting at least one key frame from the video data automatically based on a set of criteria; and
encoding the video data with a key frame identifier.

2. The method of claim 1, further comprising capturing the video data.

3. The method of claim 1, further comprising encoding the video data with key frame metadata.

4. The method of claim 1, further comprising:
dividing the video data into a set of video segments; and
associating the at least one key frame with a video segment of the set of video segments.

5. The method of claim 4, further comprising transmitting the video segment based on the at least one key frame.

6. The method of claim 4, further comprising deleting the video segment based on the at least one key frame.

7. The method of claim 4, further comprising rearranging a viewing order of the set of video segments based on the at least one key frame.

8. The method of claim 1, wherein the set of criteria includes at least one of semantic label preferences, learned preferences, and device preferences.

9. The method of claim 1, further comprising receiving a user selection of a user key frame.

10. A telecommunications apparatus that processes video data, comprising:
a key frame extractor that extracts at least one key frame from the video data automatically based on a set of criteria; and
a video encoder that encodes the video data with a key frame identifier.

11. The telecommunications apparatus of claim 10, further comprising a video capture mechanism that captures the video data.

12. The telecommunications apparatus of claim 10, further comprising a media manager that encodes the video data with key frame metadata.

13. The telecommunications apparatus of claim 10, wherein the key frame extractor divides the video data into a set of video segments and associates the at least one key frame with a video segment of the set of video segments.

14. The telecommunications apparatus of claim 13, further comprising a sharing engine that transmits the video segment based on the at least one key frame.

15. The telecommunications apparatus of claim 13, further comprising an editing engine that deletes the video segment based on the at least one key frame.

16. The telecommunications apparatus of claim 13, further comprising an editing engine that rearranges a viewing order of the set of video segments based on the at least one key frame.

17. The telecommunications apparatus of claim 10, further comprising a user interface that receives a user selection of a user key frame.

18. An electronic device that processes video data, comprising:
a video capture mechanism that captures the video data;
a key frame extractor that extracts at least one key frame from the video data automatically based on a set of criteria; and
a video encoder that encodes the video data with a key frame identifier.

19. The electronic device of claim 18, wherein the key frame extractor divides the video data into a set of video segments and associates the at least one key frame with a video segment of the set of video segments.

20. The electronic device of claim 18, further comprising a user interface that receives a user selection of a user key frame.
